(19) United States
(12) Patent Application Publication
(10) Pub. No.: US 2019/0133053 A1
(43) Pub. Date: May 9, 2019

(54) DEVICE FOR INTERCONNECTING LANDSCAPE BORDERS

(71) Applicant: Amy Dervin-Stathes, Valencia, CA (US)

(72) Inventor: Amy Dervin-Stathes, Valencia, CA (US)

(21) Appl. No.: 16/183,551

(22) Filed: Nov. 7, 2018

Related U.S. Application Data
(60) Provisional application No. 62/582,900, filed on Nov. 7, 2017.

(51) Int. Cl. A01G 9/28; F16C 11/04; F16C 11/12; F16C 11/10

(52) U.S. Cl. CPC A01G 9/28; F16C 11/10; F16C 11/12; F16C 11/04

(57) ABSTRACT

A landscape border system having a first bracket, a second bracket and an adjustable locking pivot pin. The first bracket has a first end adapted to receive a first bordering member and a second end having a first opening in a first hinge component. The second bracket has a first end adapted to receive a first bordering member and a second end having a second opening in a second hinge component. The hinge pin is adapted to be aligned and inserted along a common axis within the first and second openings in the first and second hinge components. When the hinge pin is partially inserted into a first position, the first bracket and the second bracket are adapted to pivot relative to each other. When the hinge pin is inserted deeper into a second position, the first bracket and the second bracket are locked in position and cannot pivot relative to each other.

### CROSS REFERENCE TO RELATED APPLICATION

This application claims priority to U.S. Provisional Patent Application Ser. No. 62/582,900, filed Nov. 7, 2017; the contents of which are hereby incorporated by reference herein in their entirety into this disclosure.

### TECHNICAL FIELD

The subject disclosure relates generally to landscape retaining wall systems, and more particularly, to a modular bracket for a retaining wall interconnecting landscape timbers and the like.

### BACKGROUND

Various retaining walls or borders are provided around planters, trees and the like. The borders may be comprised of timber, a composite or other type of bordering material. However, connecting two adjacent bordering members has been quite challenging. Selecting an optimum material that reduces the amount of expansion and contraction, as well as one adapted to weather harsh outdoor elements has always been difficult to solve. Consequently, there is a longstanding need for an innovative solution.

### BRIEF DESCRIPTION OF THE DRAWINGS

Various exemplary embodiments will be described in detail, wherein like reference numerals refer to identical or similar components or steps, with reference to the following figures, wherein:

FIG. 1 illustrates an upper perspective view of an exemplary landscaping interconnecting bordering system according to this subject disclosure.

FIG. 2 is a cross-sectional view of FIG. 1 along A-A.

FIG. 3A is an upper perspective view of a first member of FIG. 1.

FIG. 3B is an upper perspective view of a second member of FIG. 2.

FIG. 3C is an upper perspective view of FIG. 1 in a rotated first position.

FIG. 4 is a top view of FIG. 3A.

FIG. 5 is a side view of FIG. 3A.

FIG. 6 is a side view of FIG. 3B.

FIG. 7 is a top view of FIG. 3B.

FIG. 8 is a side view of a hinge pin of FIG. 1.

FIG. 9 is an upper perspective view of FIG. 8.

FIG. 10 is an upper perspective view of the bordering system in a first position.

FIG. 11 is an upper perspective view of the bordering system in a rotated second position.

FIG. 12 is a side view of FIG. 10.

FIG. 13 is a front view of FIG. 10.

FIG. 14. is a side view of the bordering system in a second position.

FIG. 15 is a front view of FIG. 14.

FIG. 15A is a cross-section view of FIG. 15 along B-B

FIG. 16 is a cross-section view of FIG. 15 along C-C.

FIG. 16A is a magnified view of FIG. 16.

FIG. 17 is a cross-section view of an alternate embodiment.

FIG. 18 is a cross-section view of the bordering system prior to assembly.

FIG. 18A is a magnified view of FIG. 18.

FIG. 19 is a cross-section view of FIG. 15 along D-D.

FIG. 19A is a magnified view of FIG. 19.

FIG. 20 is a cross-section view of FIG. 17 in a first position.

FIG. 21 is a semi-exploded, upper perspective view of an attachment mechanism according to this subject disclosure.

FIG. 22 is a cross-sectional view of FIG. 21 along E-E.

FIG. 23 is a semi-exploded, upper perspective of a second attachment mechanism.

FIG. 24 is a cross-sectional view of FIG. 23 along F-F.

FIG. 25 is a cut-away view of FIG. 23.

FIG. 26 is a semi-exploded, upper perspective view of a fourth attachment mechanism.

FIG. 27 is a semi-exploded, upper perspective view of a fifth attachment mechanism.

FIG. 28 is a cross-sectional view of FIG. 27 along G-G.

FIG. 29 is a top view of a sixth attachment mechanism.

FIG. 30 is a semi-exploded, upper perspective view of a seventh attachment mechanism.

FIG. 31 is a cross-sectional view of FIG. 30 along H-H.

FIG. 32 is a cross-sectional view of an eighth attachment mechanism.

FIG. 33 is a cross-sectional view of FIG. 32 along I-I.

FIG. 34 is an upper perspective view of a ninth attachment mechanism.

FIG. 35 is a cross-sectional view of FIG. 34 in a closed position.

FIG. 36 is a semi-exploded, upper perspective view of a tenth attachment mechanism.

FIG. 37 is a cross-sectional view of FIG. 36 along J-J.

FIG. 38 is a semi-exploded, upper perspective view of an eleventh attachment mechanism.

FIG. 39 is a magnified top view of FIG. 38.

FIG. 40 is a semi-exploded, magnified view of a twelfth attachment mechanism.

FIG. 41 is a cross-sectional view of a thirteenth attachment mechanism.

FIG. 42 is an upper perspective of a fourteenth attachment mechanism.

FIG. 43 is a cross-sectional view of FIG. 42 along K-K.

FIG. 44 is a partially exploded view of a fifteenth attachment mechanism.

FIG. 45 is a side view of FIG. 44.

FIG. 46 is an exploded side view of FIG. 44.

FIG. 47 is a combination of multiple landscaping interconnecting bordering systems forming a border.

FIG. 48 is a second combination of multiple landscaping interconnecting bordering systems forming a second border.

### DETAILED DESCRIPTION

Particular embodiments of the present subject disclosure will now be described in greater detail with reference to the figures.

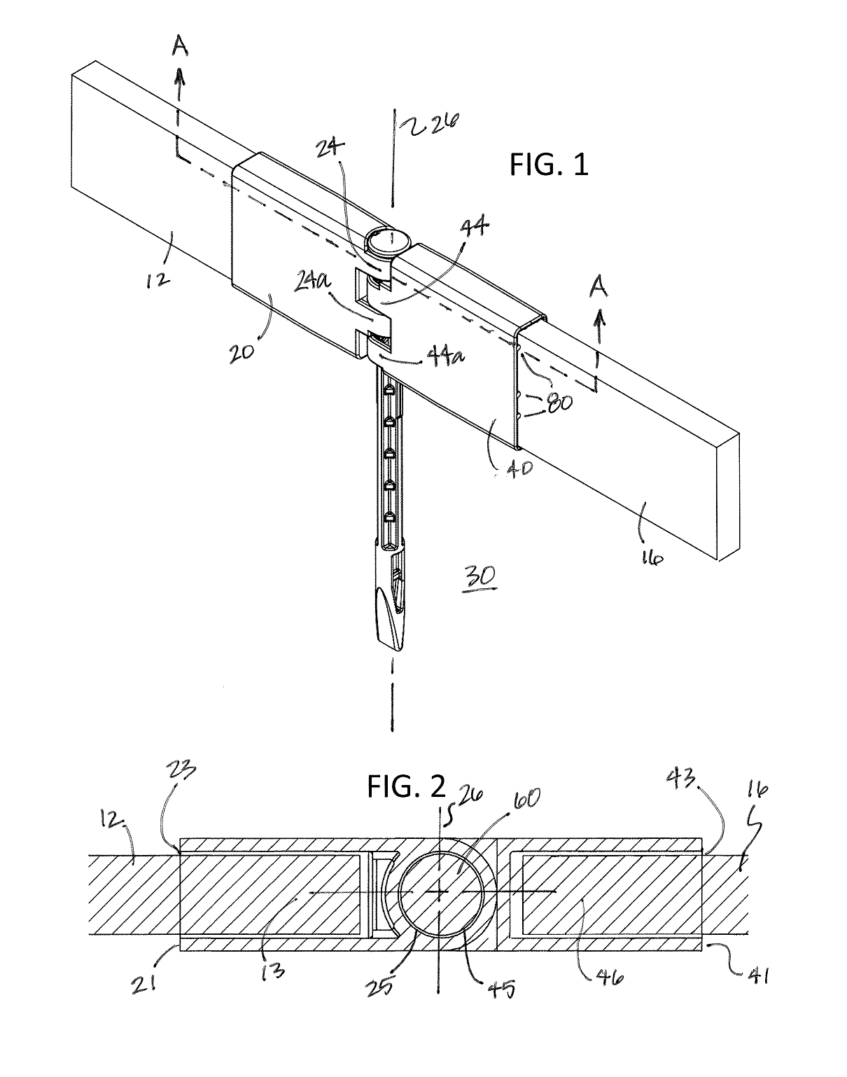

FIGS. 1-2 illustrates a landscaping interconnecting bordering system 10 and cross section. The bordering system 10 includes connecting a first member 12 to a second member 16 in a garden or other area requiring a border. The first member 12 or the second member 16 may be a landscape member and/or any other suitable member for providing a border.

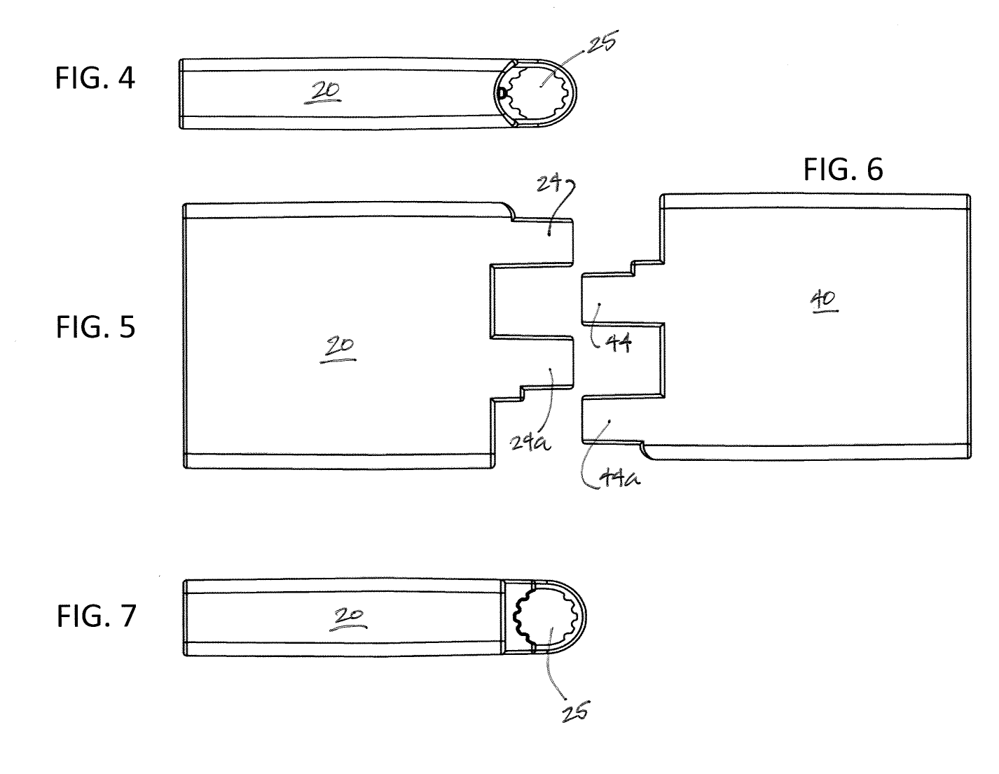

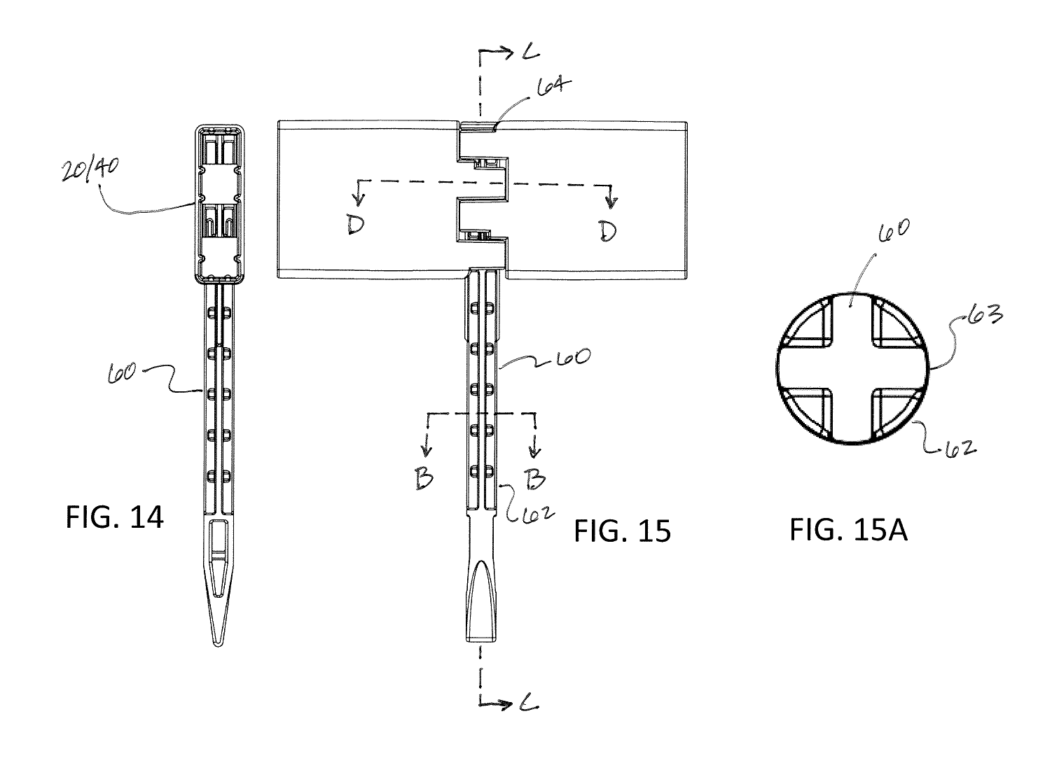

FIGS. 1-5 and 10-15 depict the first bracket 20 (and the second bracket 40) being shaped to engage a first end 13 of the first member 12. A first end 21 of the first bracket 20 includes an opening 23 into which the first end 13 of the first member 12 is slid therein. The opening 23 may be constructed as a hollow channel into which the first end 13 of the first member 12 is disposed.

A second end 22 of the first bracket 20 is constructed in the shape of a first hinge component 24. The first hinge component 24 may include one or more 24a hinge elements having a pivot opening 25 through which a hinge pin 60 may pass through.

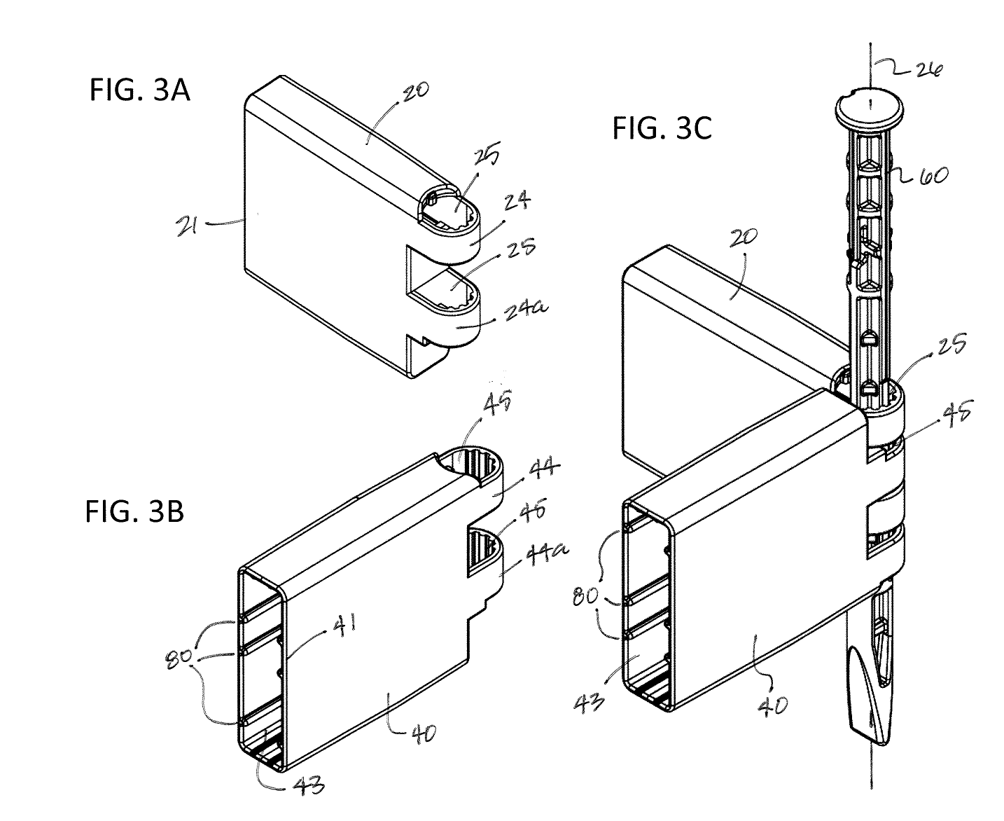

FIGS. 1, 3B and 3C illustrate the second bracket 40 is shaped to engage a first end 41 of the second member 16. A first end 41 of the second bracket 40 includes an opening 43 into which the first end 46 of the second member 16 is slid therein. The opening 43 may be constructed as a hollow channel into which the first end 41 of the second member 16 is disposed.

A second end 42 of the second bracket 40 is constructed in the shape of a second hinge component 44. The second hinge component 44 may include one or more 44a hinge elements having a pivot opening 45 through which the hinge pin 60 may pass through.

The pivot opening 25 of the first hinge component 24 and the pivot opening 45 of the second hinge component 44 are adapted to align along the common, substantially vertical pivot axis, generally designated 26 as shown in FIGS. 1 and 3C. The first hinge component 24 and the second hinge component 44 are adapted to overlap, interlace and/or stack adjacent to each other along the vertical pivot axis 26.

FIGS. 1, 3C and 8-15 show the hinge pin 60 being shaped to engage the pivot openings 25, 45 of the first and second hinge components 24 and 44, respectively, along the common pivot axis 26 and extend downwardly into the ground, generally designated 30, beneath the bordering system 10.

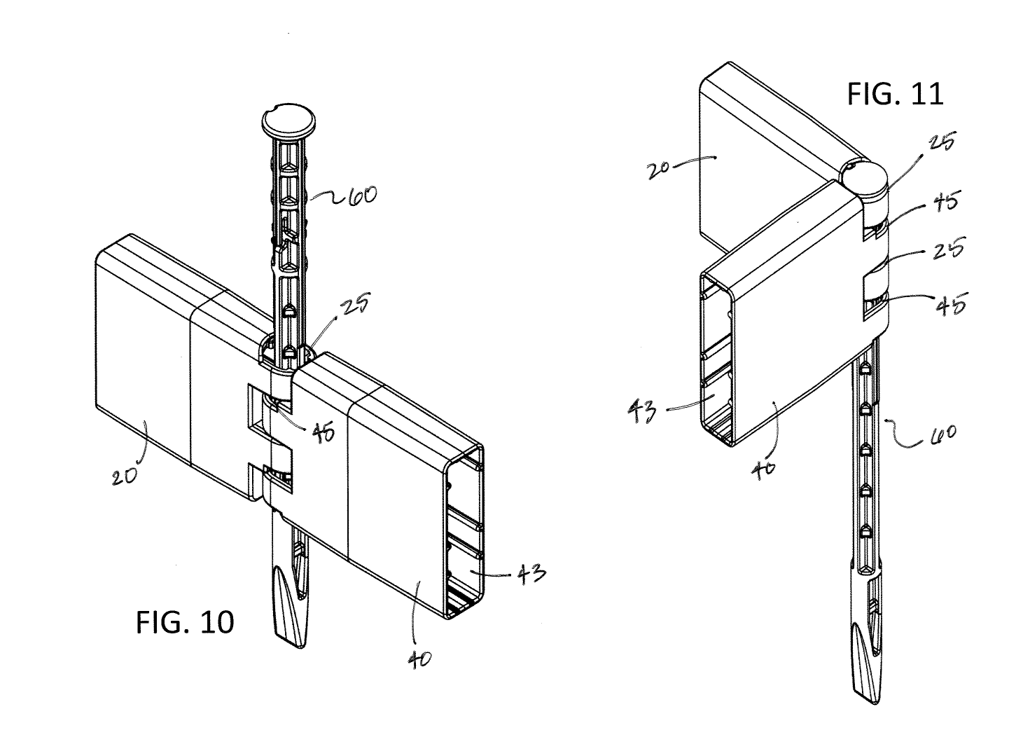

As shown in FIGS. 3C and 10-15, the hinge pin 60 is constructed to cause different operations in at least two different positions. In a first position (FIGS. 3C and 10), the hinge pin 60 is partially disposed into the pivot openings 25 and 45 of the first and second hinge components 24 and 44, respectively. In this first position, the first hinge component 24 and the second hinge components 44 are allowed to pivot along the pivot axis 26 relative to each other as shown in FIGS. 3C and 10. In this manner, a user can manipulate the relative positions of the first and second brackets 20, 40 as desired.

In a second position (FIGS. 1, 11 and 14-15), the hinge pin 60 is pushed deeper and/or further into and through the pivot openings 25 and 45 of the first and second hinge components 24 and 44, respectively. In this second position, the hinge pin 60 is locked into position within the pivot openings 25 and 45 of the first and second hinge components 24 and 44. The hinge pin 60 is staked into the ground 30 and the first and second hinge components 24 and 44 are fixed relative to each other. The hinge pin 60 may be pressed and/or hammered all the way into the ground 30 and the hinge pin 60 anchors and fixes the first and second hinge components 24 and 44 of the first and second brackets 20, 40 of the bordering system 10 to the ground 30.

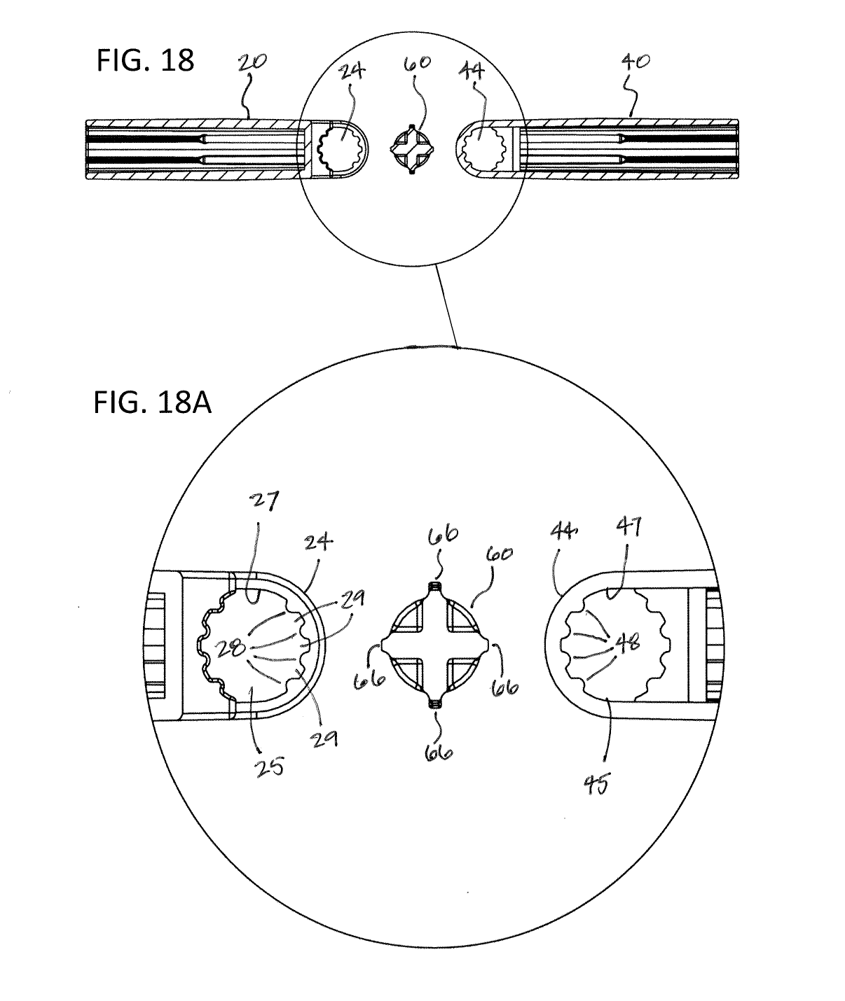

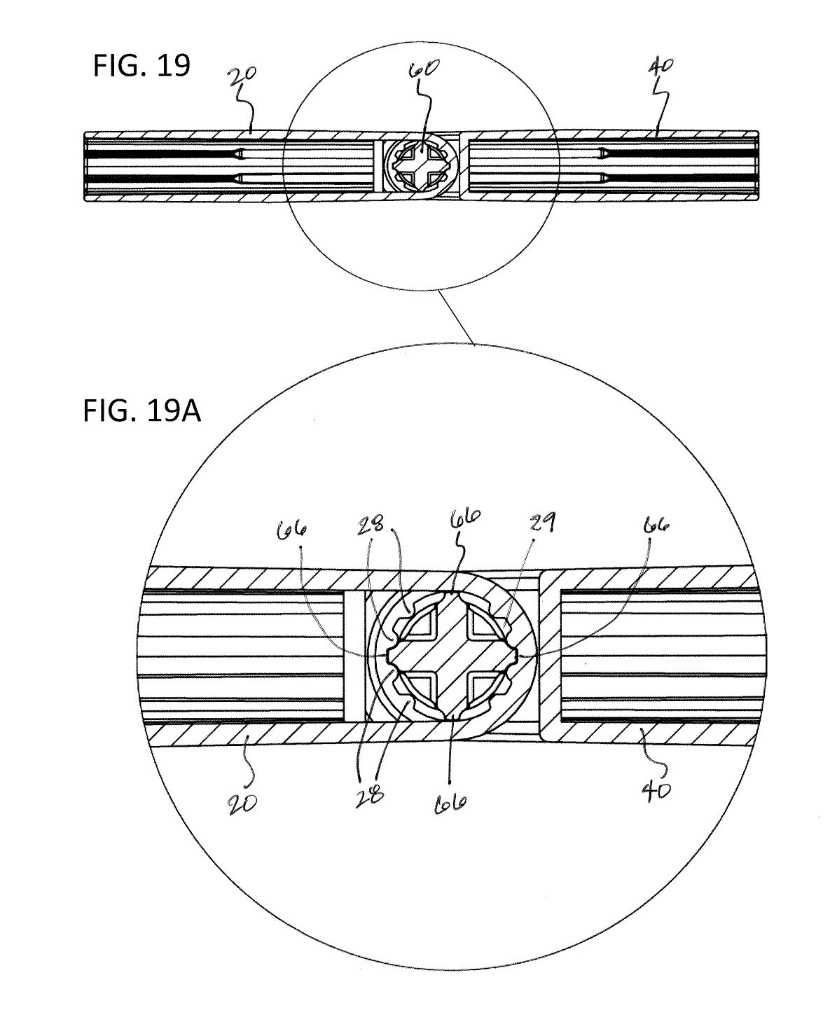

FIGS. 18-19 show in more detail the hinge pin 60 and the inner surfaces 27 and 47 of the pivot openings 25 and 45 of the first and second hinge components 24 and 44 consist of a mating locking mechanism. FIGS. 18-19 show a cross section view of the hinge pin 60 and the first and second hinge components 24 and 44 about two locations in FIG. 15.

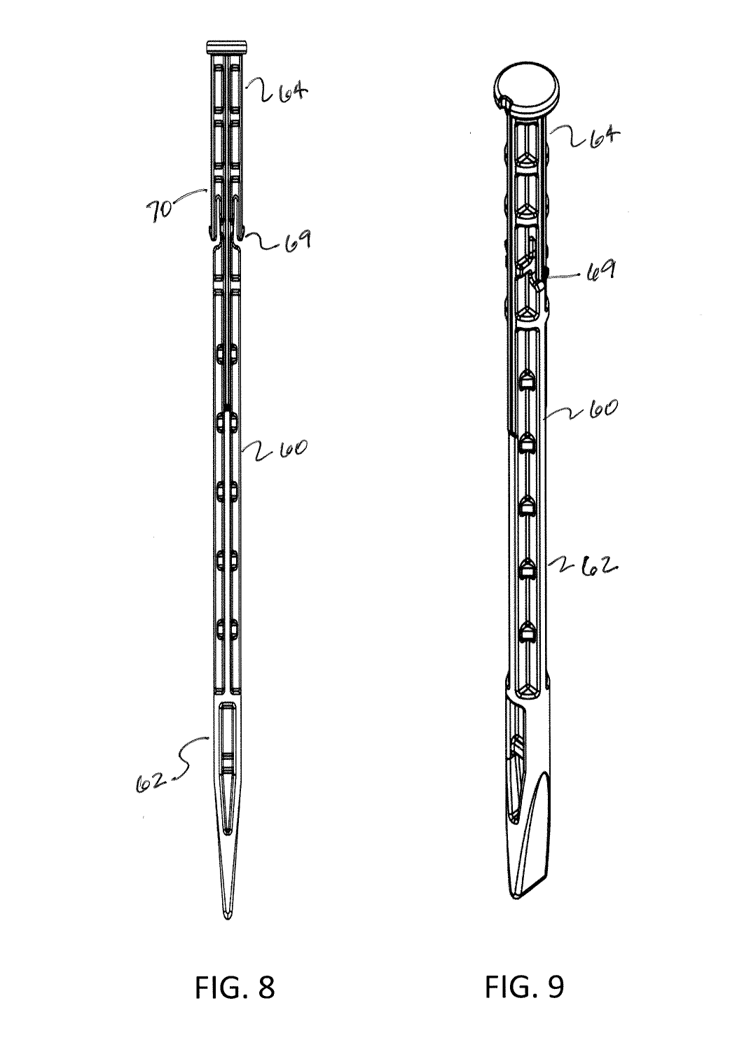

FIG. 15A shows the cross section at FIG. 8 about a first end 62 of the hinge pin 60 as shown. At this position, the hinge pin 60 has a smooth outer surface 63 and is adapted to allow the inner surfaces 27, 47 of the pivot openings 25 and 45 of the first and second hinge components 24 and 44 to pivot by rotation freely around the hinge pin 60 when the hinge pin 60 is in the first position.

FIG. 19 shows a cross section view through FIG. 15 about a second end 64 of the hinge pin 60. FIGS. 18 and 18A show an exploded cross section view of FIG. 19 prior to assembly. At this position, the hinge pin 60 has one or more alignment pin protrusions 66. Other alignment projections are possible and may be constructed onto the hinge pin 60 according to this subject disclosure.

In FIG. 18A, the inner surfaces 27, 47 of the pivot openings 25 and 45 of the first and second hinge components 24 and 44 are shown. Likewise, a cross section through the pivot pin 60 is also shown. As shown on the left side of FIGS. 18A, the inner surface 27 of the pivot opening 25 of the first hinge component 24 includes various hinge projections 28. It is to be understood that one or more hinge projections 28 may be provided. Various gaps 29 are disposed between the hinge projections 28 into which the pin protrusions 66 may be aligned.

In FIG. 18A, the inner surface 47 of the pivot opening 45 of the second hinge component 44 also includes various hinge projections 48. It is to be understood that one or more hinge projections 48 may be provided. Various gaps 49 are disposed between the hinge projections 48 into which the pin protrusions 66 of the hinge pin 60 may also be aligned.

In the second locked position shown in FIGS. 15 and 19, the pin protrusions 66 on the hinge pin 60 are disposed within the gaps 29, 49 of the hinge projections 28, 48 disposed on the inner surfaces 27, 47 of the pivot openings 25, 45 of the first and second hinge components 24, 44. In this second position when the hinge pin 60 has been inserted all the way into the pivot openings 25, 45, the hinge pin 60 is locked in position and rotation of the first and second brackets 20, 40 is not possible.

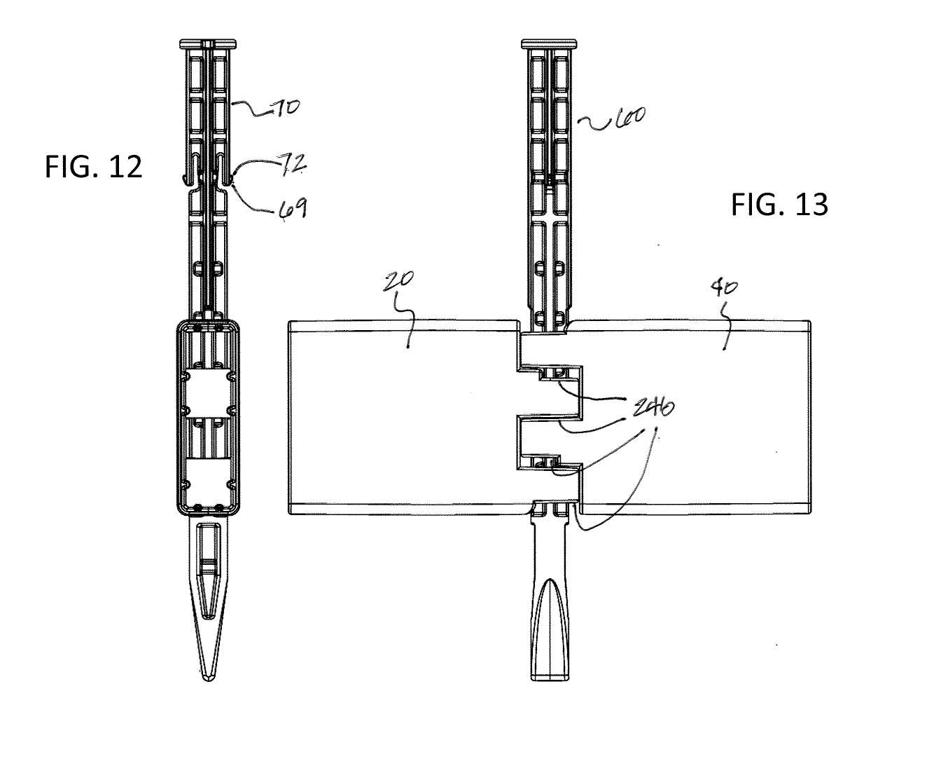

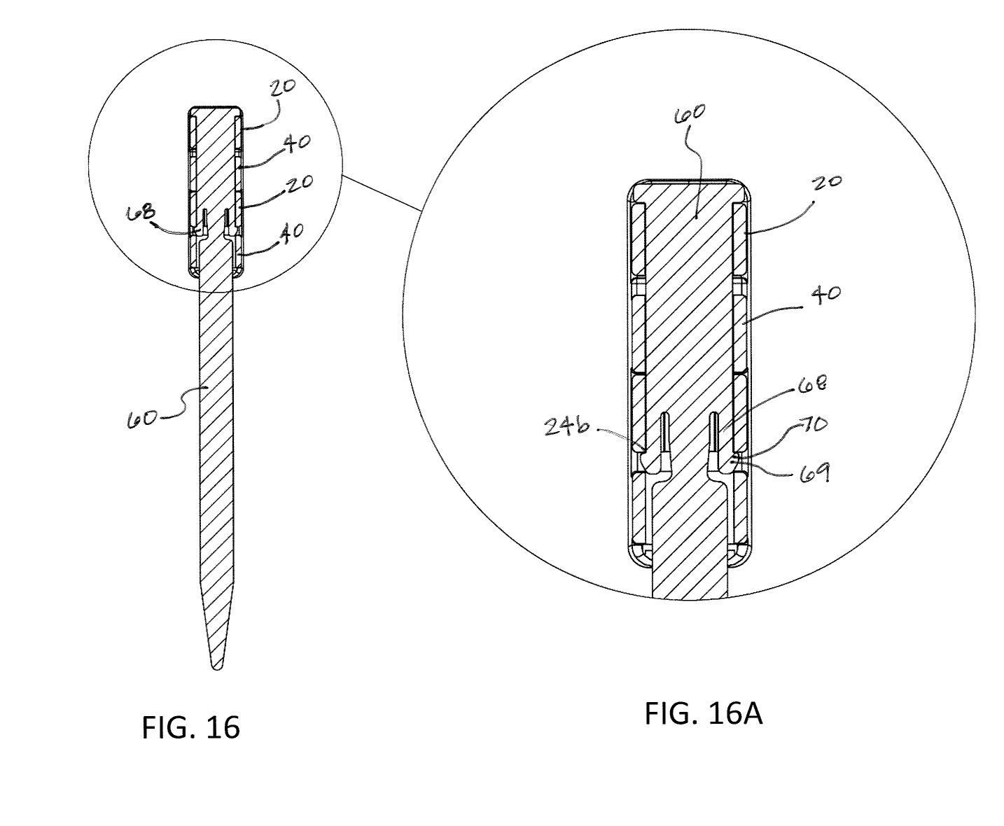

FIGS. 8, 12, 16, 16A and 17 provide a snap lock clip 68 to prevent the hinge pin 60 from backing out of the pivot openings 25, 45 of the first and second hinge components 24, 44 when it is locked into place in the second position. The snap lock clip 68 is constructed in to the hinge pin 60. The clip 68 includes a pair of resilient snap-type hooks 69 that extend from an outer surface 70 of the hinge pin 60 at about a central location as shown in FIGS. 8 and 12.

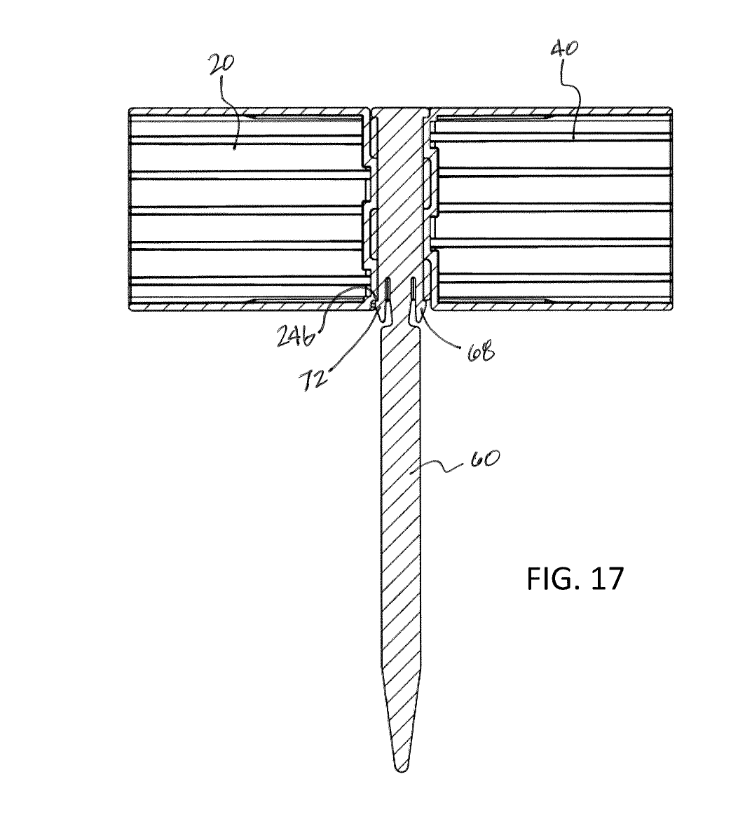

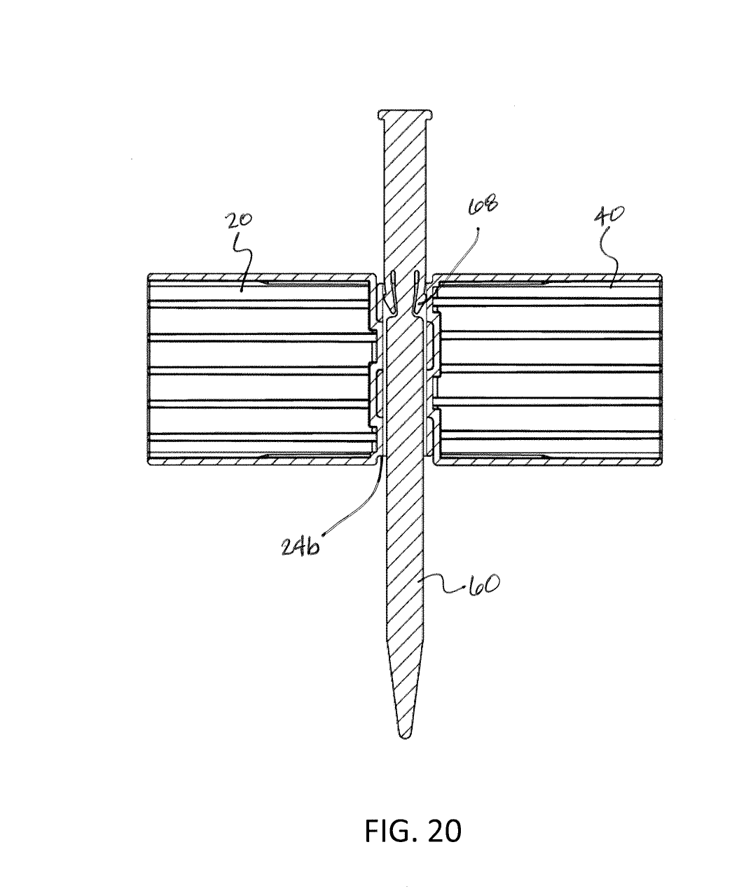

In use, the pair of resilient snap-type hooks 69 acts as springs. As shown in FIG. 20, as the hinge pin 60 slides through the pivot openings 25, 45, the hooks 69 compress inward and slide along the inner surfaces 27, 47 of the pivot openings 25, 45. When the hinge pin 60 has been pushed into and beyond the pivot openings 25, 45 a predetermined distance (as shown in FIG. 17), the hooks 69 may spring outward locking outermost hooked ends 72 against an edge or surface 24b of one of the first or second hinge components 24, 44 thereby locking the clip 68 within the pivot openings 25, 45 and preventing it from backing out unless the hooked ends 72 are depressed by a user. As shown in FIG. 13, the edge or surface 24b that the hooked ends 72 may be attached to can be a variety of different locations such as shown in FIG. 13.

The bordering system 10 may include various additions and/or modifications to its structure according to this subject disclosure. Various attachment mechanisms for the bordering system 10 will be described in more detail below.

In FIGS. 1, 3B and 3C, various ribs 80 may be provided along an inside of the walls of the first and second brackets 20, 40. The ribs 80 provide a tight friction fit with the first and second members 12, 16 to assist in securing the first and second members 12, 16 in place within the first and second brackets 20, 40. A predetermined suitable interior length of the first and second members 12, 16 is selected to allow the first and second members 12, 16 to move via expansion and/or contraction within the first and second brackets 20, 40 when the outdoor temperature is hotter and/or colder. For example, at different times of the year when the outside temperature fluxuates, the first and second members 12, 16 may expand and contract, the interior length of the first and second brackets 20, 40 allows for this contraction and expansion of the first and second members 12, 16. The ribs 80 secure a tight fit hold of the first and second members 12, 16 within the first and second brackets 20, 40 when they expand and contract.

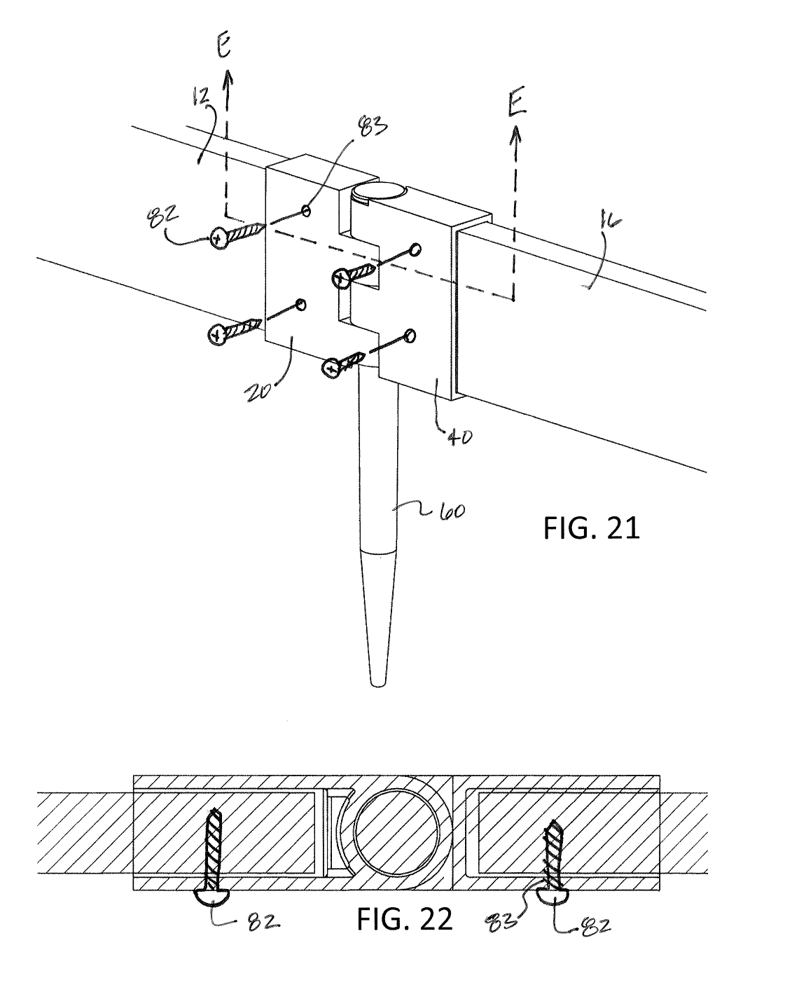

FIGS. 21-22 show the use of one type of an attachment mechanism or fastener. This fastener is a threaded fastener or screw 82. The screws 82 are screwed through an aperture 83 in the first and second brackets 20, 40 and into the first and second members 12, 16 to provide a secure connection.

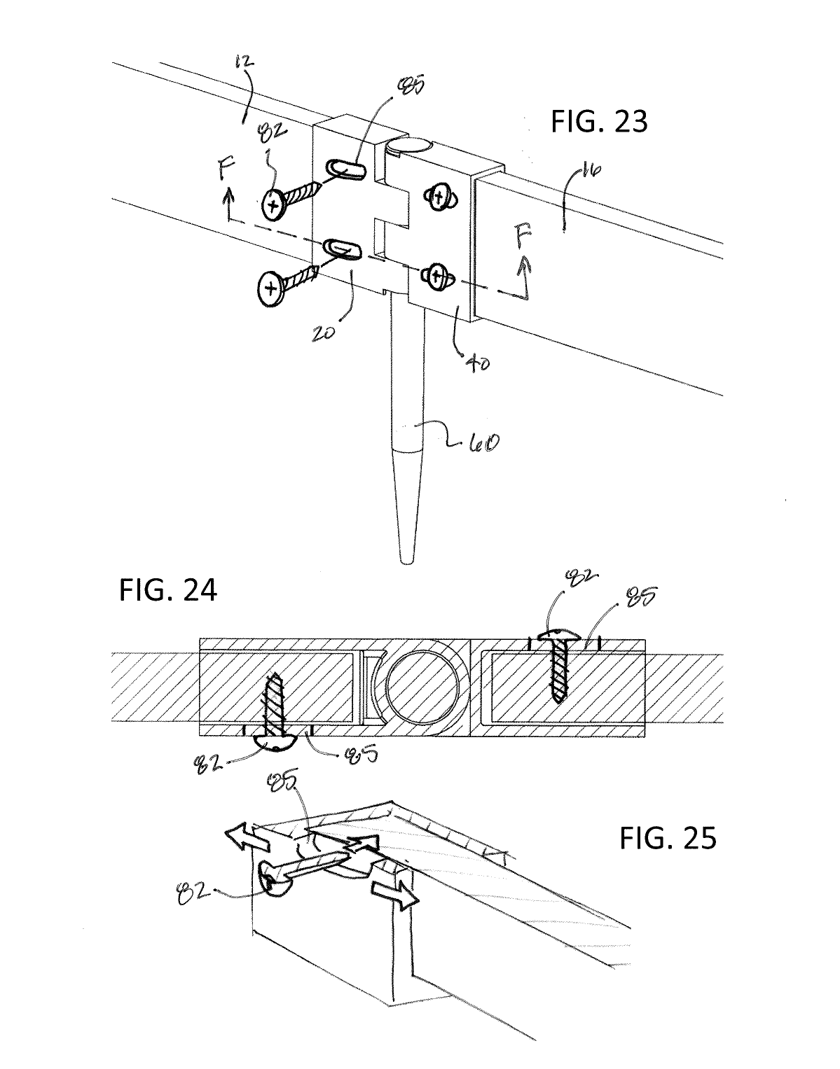

FIGS. 23-25 illustrate that addition of slots 85 used in combination with the threaded fasteners 82. The screws 82 are screwed through the slots 85 in the first and second brackets 20, 40 and into the first and second members 12, 16 to provide a secure connection. As shown, the first and second members 12, 16 are able to shift or slide from side to side within the slots 85 a distance defined by a width of the slots 85 and the thickness of the screw 82 which acts as the stop at each end of the slot 85. This distance of travel allows for the expansion and/or contraction of the first and second members 12, 16 during colder and/or hotter days.

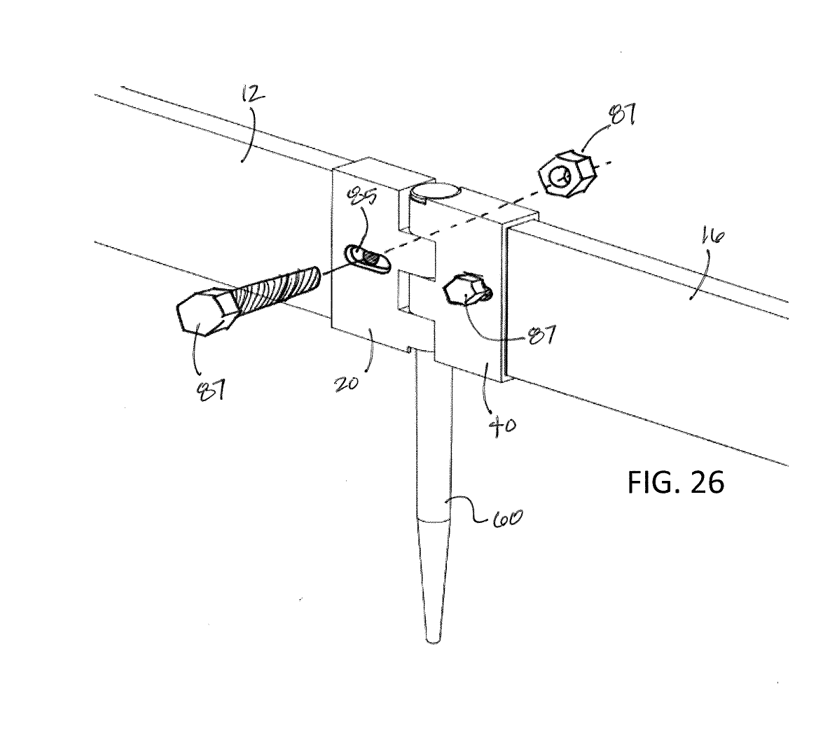

FIG. 26 shows that the fastener may be a bolt and nut fastener 87. As such, the bolt and nut fastener 87 is threaded through the slot 85 and through the first and second members 12, 16 respectively. As before, the first and second members 12, 16 are able to shift or slide from side to side within the slots 85 a distance defined by a width of the slots 85 and the thickness of the bolt and nut fastener 87 which acts as the stop at each end of the slot 85.

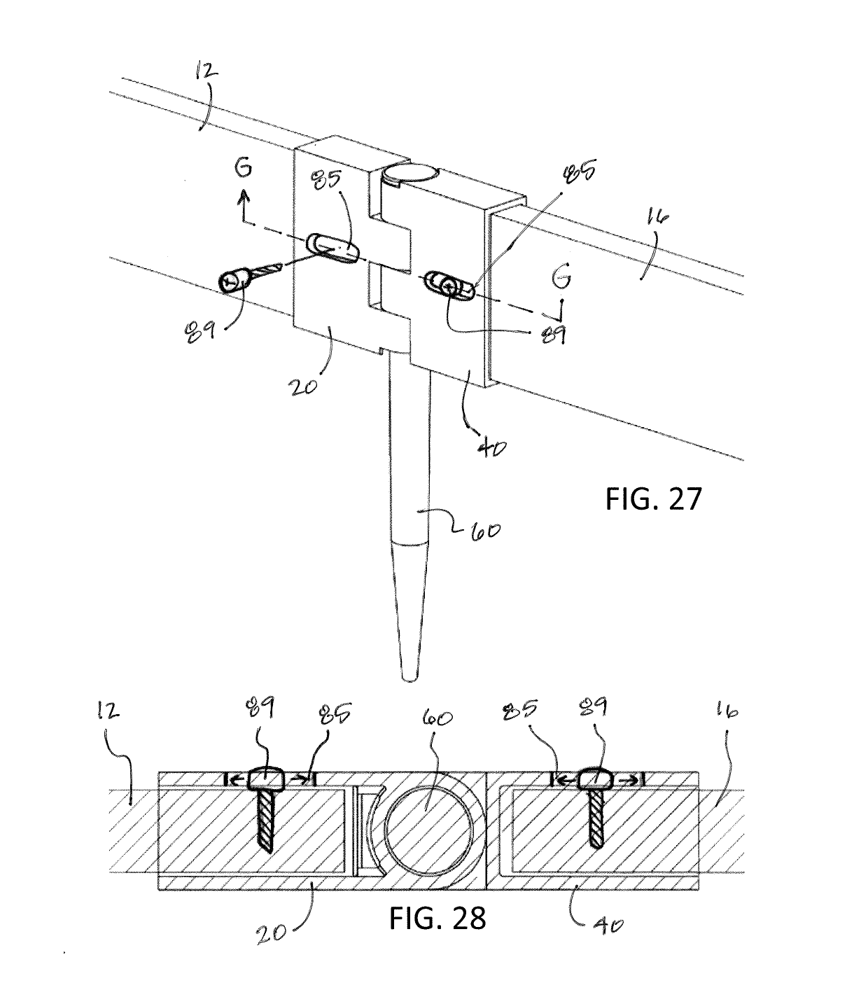

In FIGS. 27-28, inset screws 89 may be used. A cylindrical screw head of the inset screws 89 sits flush into the connector slot 85. The cylindrical screw head of the inset screw 89 is also able to shift or slide from side to side within the slots 85 and the thickness of the cylindrical screw head acts as the stop at each end of the slot 85. The slots 85 allow natural movement of the first and second members 12, 16.

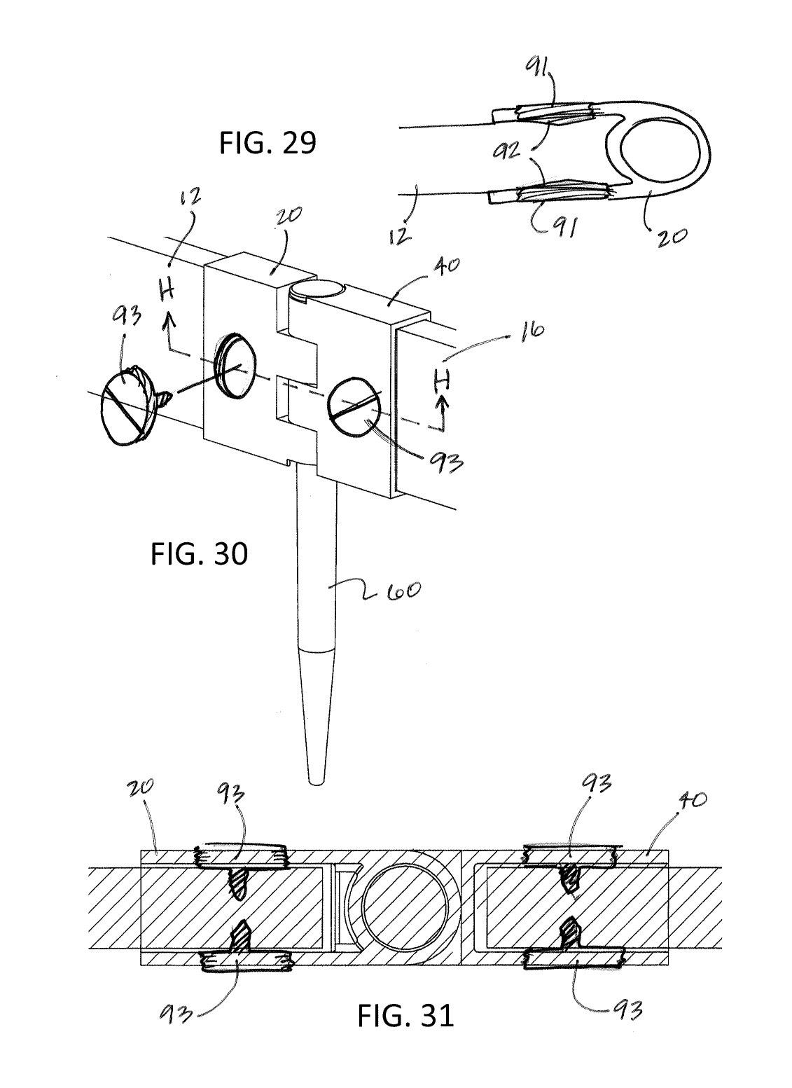

FIG. 29 illustrates another alternative in which a fastener head 91 are fastened into the first and second brackets 20, 40 and butt up against the first and second members 12, 16. Tightening the fastener head 91 against the first and second members 12, 16 provides a friction fit against them. The fastener head 91 do not thread into the first and second members 12, 16 but instead a back side bump 92 applies a force against the first and second members 12, 16 respectively to wedge them in place as shown.

Alternatively, FIGS. 30-31 show other fastener screws 93 having a threaded tip that also screws directly into the first and second members 12, 16.

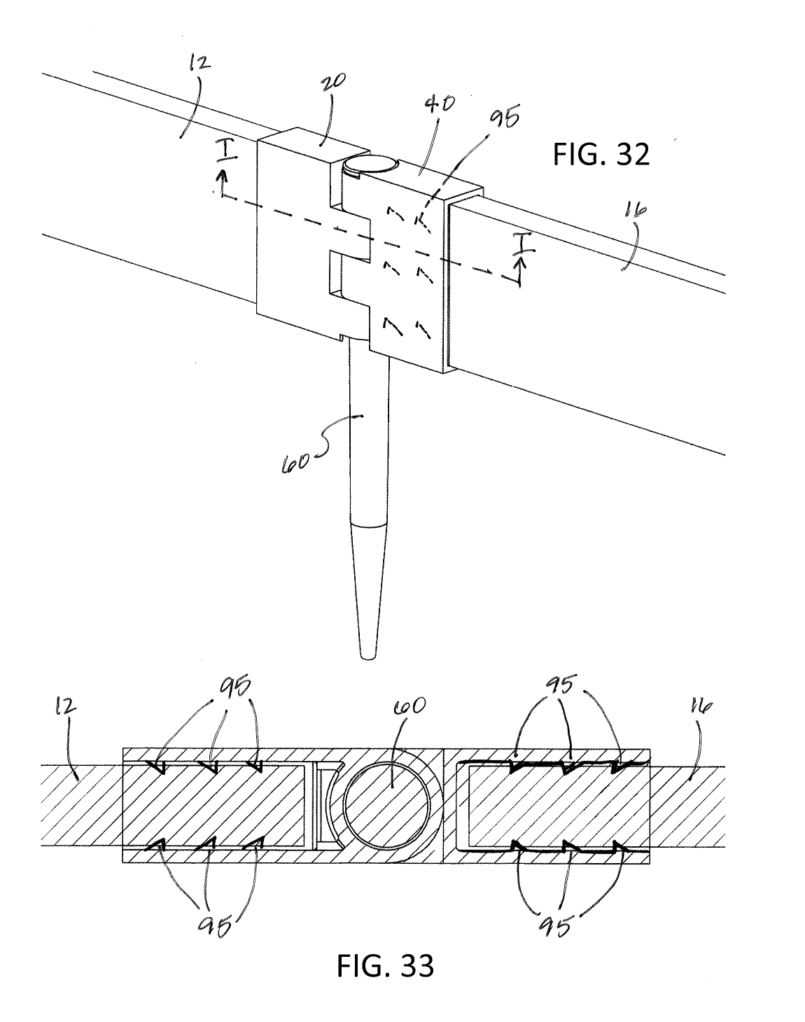

FIGS. 32-33 depict the use of directional teeth 95 disposed on an inner surface of the first and second brackets 20, 40. The directional teeth 95 are provided to secure the first and second members 12, 16. In use, the first and second members 12, 16 are inserted into the first and second brackets 20, 40, then locks them from being pulled back out. Likewise, if the first and second members 12, 16 expand, expansion is possible but contraction out of the first and second brackets 20, 40 is not possible as the directional teeth 95 prevent reverse movement of the first and second members 12, 16.

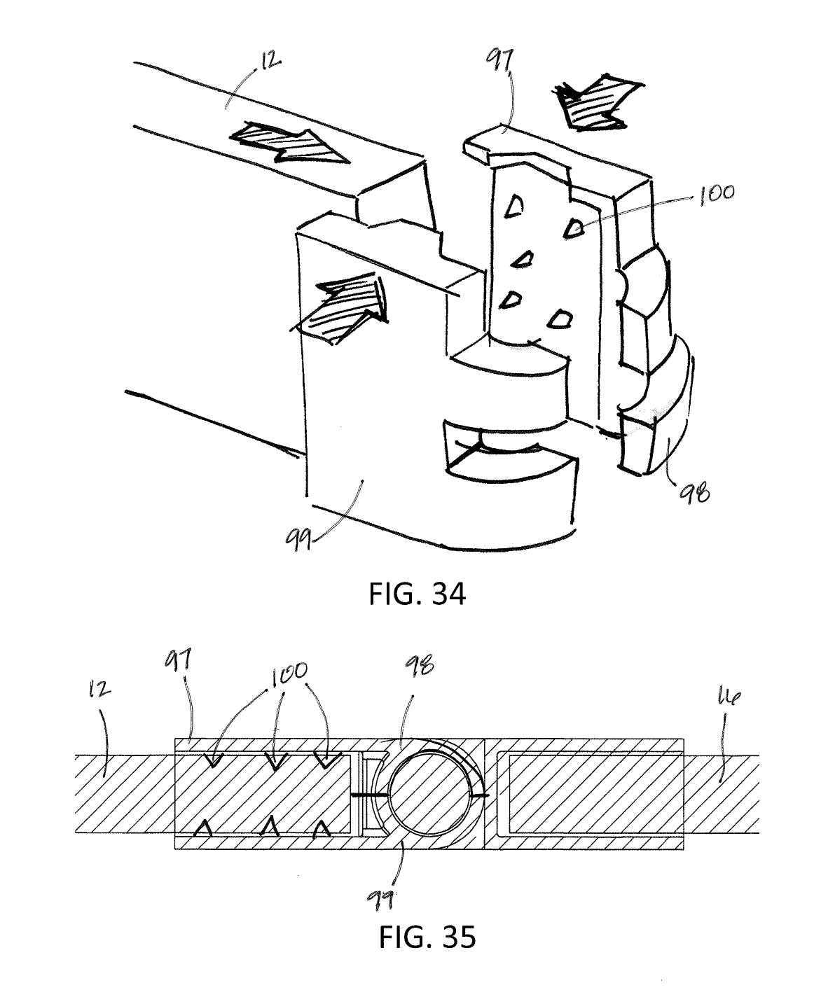

FIGS. 34-35 depict the use of a clamp 97 configuration with teeth 100. The clamp 97 includes a first clamp side 98 and a second clamp side 99. The teeth 100 clamp together onto the first and second members 12, 16 and around the hinge pin 60 as the first clamp side 98 and the second clamp side 99 come together to secure the first and second members 12, 16 respectively. Various other configurations are shown in the attached figures.

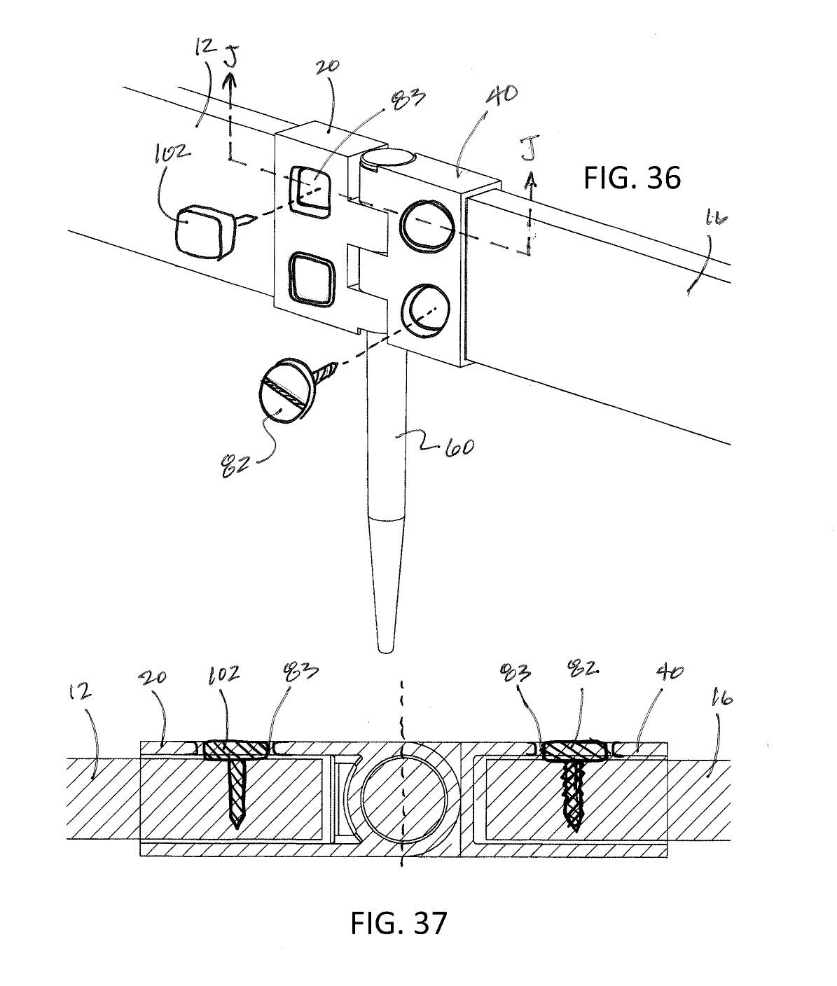

FIGS. 36-37 illustrate the versatility of this subject disclosure. As shown, various fasteners may be used to secure the first and second members 12, 16. The various fasteners may include but are not limited to a nail 102 and/or an inset screw 89 combination. When the nail 102 is employed, the nail may be hammered into the first or second member 12, 16 so that the head of the nail nests into an aperture 83 in the first or second member 12, 16 and sits flush with the outer surface of the first or second bracket 20, 40. Using a fastener with a head that is slightly smaller than the aperture 83 in the first or second member 12, 16 allows movement of the first or second members 12, 16 during temperature change which causes expansion and/or contraction.

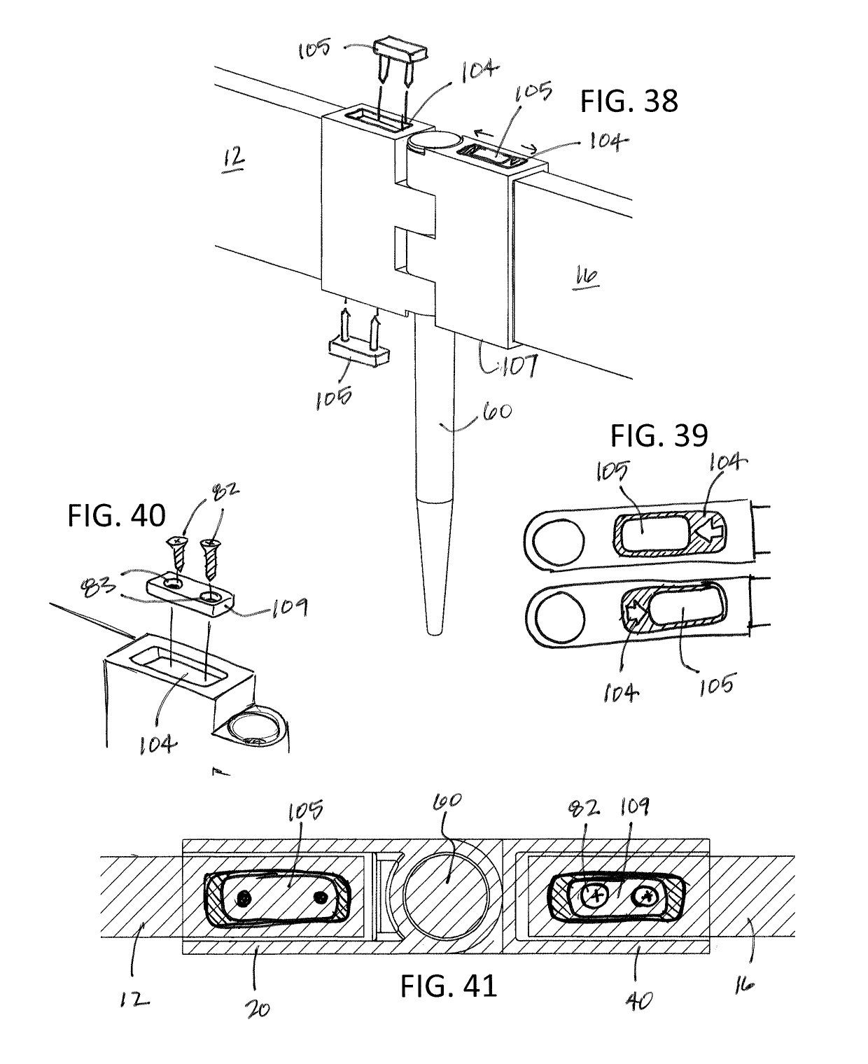

FIGS. 38-41 illustrate various other fasteners in which the fastening element is attached through an aperture 104 disposed in an upper 106 and lower 107 side of the first and second brackets 20, 40. In FIG. 37, a custom nail 105 may be employed that is hammered into the aperture 104 in the upper 106 and lower 107 side of the first and second brackets 20, 40. As shown, the aperture 104 is slotted and encourages movement of the first or second members 12, 16 to allow for the shrinkage and expansion of the first and second members 12, 16. Alternatively, FIG. 40 shows a plate 109 including apertures 83 into which the screws 82 may be threaded through and into the first and second members 12, 16 respectively. As shown in FIG. 41, the combination of the custom nail 105 and the plate 109 and screw 82 fasteners may be used to secure the first and second members 12, 16 respectively.

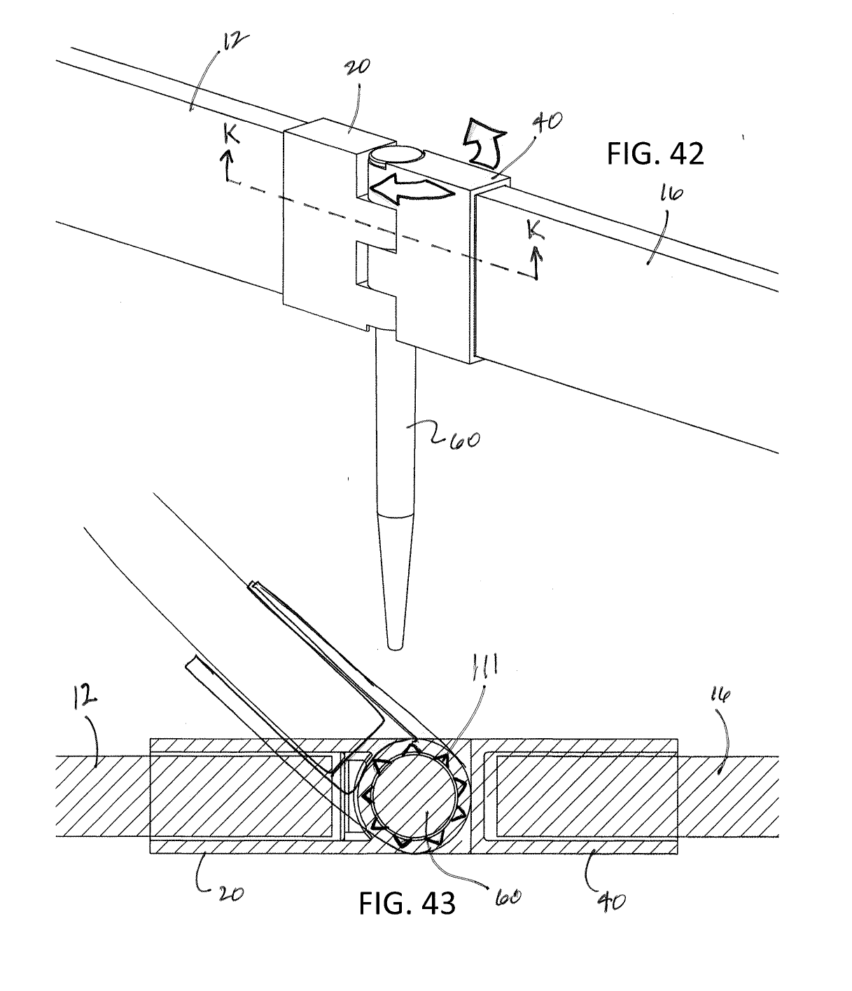

FIGS. 42-43 show another exemplary embodiment in which the connection between the hinge pin 60 and the first and second hinge components 24, 44 include a series of teeth 111. The series of teeth 111 act as a lock when the hinge pin 60 is pressed through the pivot openings 25, 45 in the first and second hinge components 24, 44.

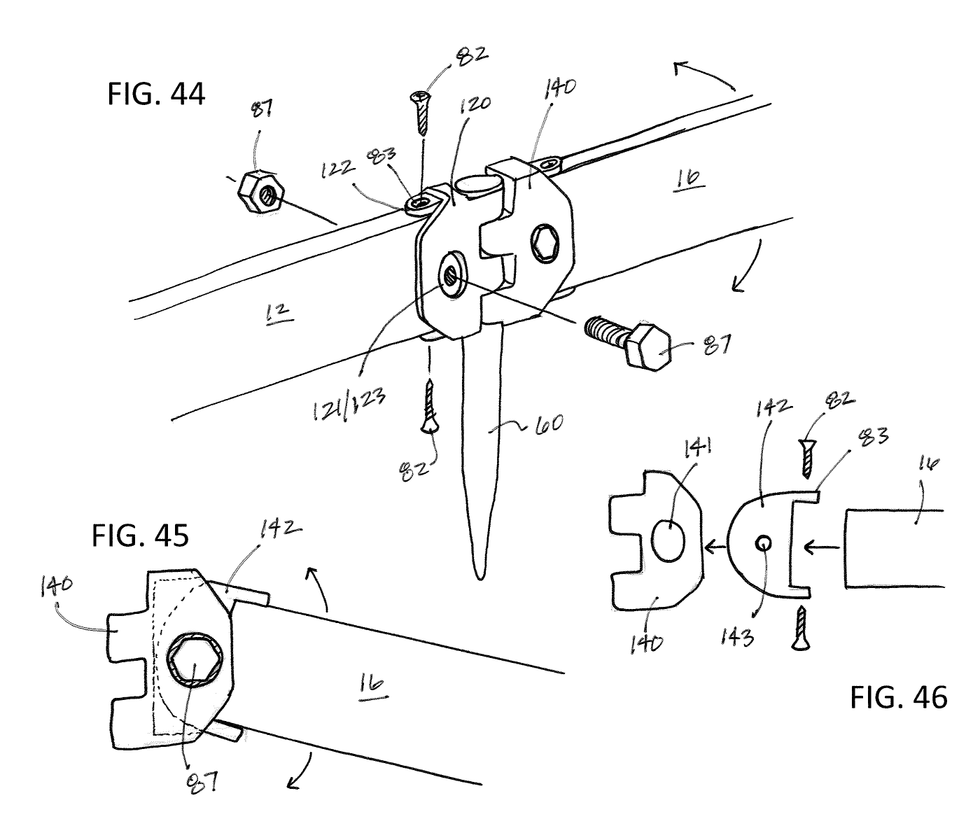

FIGS. 44-46 illustrate another exemplary embodiment in which the bordering system 10 is capable of pivoting in two directions. As shown, the bordering system 10 includes a first bracket 20 made of two components, a first bracket 120 and a swivel bracket 122. Both the first bracket 120 and the swivel bracket 122 have mating apertures 121, 123. A fastener, such as the bolt and nut fastener 87 is disposed through the mating apertures 121, 123. The swivel bracket 122 is attached to the first member 12 by fasteners 82 and the swivel bracket 122 is then attached to the first bracket 120 such that the swivel bracket 122 can swivel within the first bracket 120.

In this manner, the first bracket 120 permits pivot rotation around an axis through the hinge pin 60, and the swivel bracket 122 permits pivot rotation around a second axis defined through the bolt and nut fastener 87 length. Thus, according to this subject disclosure, this bordering system can pivot in two directions.

As shown in FIGS. 45 and 46, a second bracket 140 and a second swivel bracket 142 is provided. Both the second bracket 140 and the second swivel bracket 142 have mating apertures 141, 143. A fastener, such as a bolt and nut fastener 87 is disposed through the mating apertures 141, 143. The second swivel bracket 142 is attached to the second member 16 by fasteners 82 and the second swivel bracket 142 is then attached to the second bracket 140 such that the second swivel bracket 142 can swivel within the second bracket 140.

As before, the second bracket 140 permits pivot rotation around an axis through the hinge pin 60 (as shown in FIG. 44), and the second swivel bracket 142 permits pivot rotation around another axis defined through the bolt and nut fastener 87 (as shown in FIG. 44) length disposed in the second bracket 140. Thus, this second bracket 140 and second swivel bracket 142 connection can also pivot in two directions.

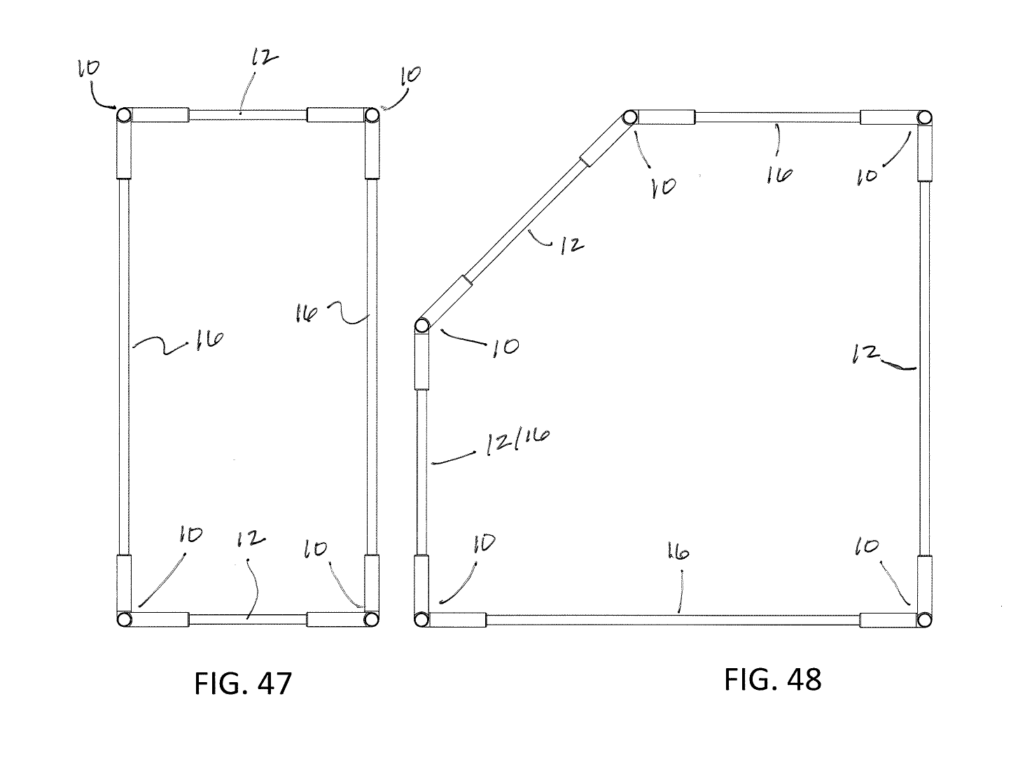

FIGS. 47-48 illustrates the versatility in which the bordering system 10 can be used to interconnect various first and second members 12, 16 into various geographic shaped boundaries for a variety of different uses.

1. A landscape border system, comprising:
a first bracket having a first end adapted to receive a first border member and a second end having a first hinge component with a first opening;
a second bracket having a first end adapted to receive a second border member and a second end having a second hinge component with a second opening;
an adjustable hinge pin adapted to be aligned and inserted along a common axis disposed through the first and second openings in the first and second hinge components, wherein when the adjustable hinge pin is inserted into:
a first position, the first bracket and the second bracket are allowed to pivot relative to each other; and
a second position, the first bracket and the second bracket are locked in position and cannot pivot relative to each other.

2. The landscape border system recited in claim 1, wherein the adjustable hinge pin is locked in position by a locking mechanism provided between an outer surface of the hinge pin and an inner surface of at least one of the first and second hinge components.

3. The landscape border system recited in claim 2, wherein the outer surface of the hinge pin has a pin protrusion, and the inner surface of at least one of the first and second hinge components has a mating hinge projection.

4. The landscape border system recited in claim 3, wherein the pin protrusion is concentrically locked by the mating hinge projection.

5. The landscape border system recited in claim 1, wherein the adjustable hinge pin has a plurality of pin protrusions disposed on an outer surface that are aligned within gaps disposed between a plurality of mating hinge projections disposed on an inner surface of the first and second hinge components.

6. The landscape border system recited in claim 1, wherein the adjustable hinge pin has a clip that locks the adjustable hinge pin within the first and second brackets.

7. The landscape border system recited in claim 1, wherein the adjustable hinge pin has a resilient clip with hooks that lock onto one of the first or second hinge components.

8. The landscape border system recited in claim 1, wherein the adjustable hinge pin has a resilient clip with hooks, the hooks extend from an outer surface of the hinge pin and lock onto one of the first or second hinge components.

9. The landscape border system recited in claim 1, wherein as the hinge pin has a resilient clip with hooks that slide a predetermined distance along inner surfaces of the first and second openings, wherein the hooks compress inward along the inner surfaces until edge of the inner surfaces are reached allowing the hooks to spring outward, locking outermost hooked ends against a surface of one of the first or second hinge components, thereby locking the clip within the first and second openings.

10. A landscape border system, comprising:
a first bracket having a first end adapted to receive a first border member and a second end having a first hinge component with a first opening;
a second bracket having a first end adapted to receive a second bordering member and a second end having a second hinge component with a second opening;
an adjustable hinge pin aligned and inserted along a common axis disposed through the first and second openings, wherein when the adjustable hinge pin is inserted into:
a first position, the first and second bracket pivot relative to each other; and
a second position, the first and second bracket are locked in position and cannot pivot.

11. The landscape border system recited in claim 10, wherein the adjustable hinge pin is locked in position by a locking mechanism provided between an outer surface of the hinge pin, and an inner surface of at least one of the first and second hinge components.

12. The landscape border system recited in claim 10, wherein the adjustable hinge pin is locked in position via locked engagement between a pin protrusion on an outer surface of the hinge pin, and a mating hinge projection disposed on an inner surface of at least one of the first and second hinge components.

13. The landscape border system recited in claim 10, wherein the adjustable hinge pin has a plurality of pin protrusions disposed on an outer surface that are aligned within gaps disposed between a plurality of mating hinge projections disposed on an inner surface of the first and second hinge components.

14. The landscape border system recited in claim 10, wherein the adjustable hinge pin has a clip that locks the adjustable hinge pin within the first and second brackets.

15. The landscape border system recited in claim 10, wherein the adjustable hinge pin has a resilient clip with hooks, the hooks extend from an outer surface of the hinge pin and lock onto one of the first or second hinge components.

16. The landscape border system recited in claim 10, wherein the hinge pin has a resilient clip with hooks that slide a predetermined distance along the inner surfaces of the first and second openings, the hooks compress inward along inner surfaces until edges of the inner surface are reached and the hooks spring outward locking, outermost hooked ends against an edge surface of one of the first or second hinge components.

17. A landscape border system, comprising:
a first bracket having a first end adapted to receive a first border member and a second end having a first hinge component with a first opening with at least one hinge projection;
a second bracket having a first end adapted to receive a second border member and a second end having a second hinge component with a second opening having at least one hinge projection;
an adjustable hinge pin having pin protrusions, the adjustable hinge pin aligned and inserted along a common axis disposed through the first and second openings, wherein when the adjustable hinge pin is inserted into:
a first position, the first and second brackets are allowed to pivot relative to each other; and
a second position, the hinge projections engage the pin protrusions to lock the first and second brackets from being pivoted.

18. The landscape border system recited in claim 17, wherein the adjustable hinge pin has a clip that locks the adjustable hinge pin onto one of the first and second brackets.

19. The landscape border system recited in claim 17, wherein the adjustable hinge pin has a resilient clip with hooks that extend from an outer surface of the hinge pin and that lock onto one of the first or second hinge components.

20. The landscape border system recited in claim 17, wherein the adjustable hinge pin has a resilient clip with hooks that slide a predetermined distance along the inner surfaces of the first and second openings, the hooks compress inward along inner surfaces until edges of the inner surface are reached and the hooks spring outward locking, outermost hooked ends against an edge surface of one of the first or second hinge components.
